(19) United States
(12) Patent Application Publication
(10) Pub. No.: US 2020/0367504 A1
(43) Pub. Date: Nov. 26, 2020

(54) Compositions Comprising Water-Soluble Herbicides And Use Thereof

(71) Applicant: Clariant International Ltd., Muttenz (CH)

(72) Inventors: Peter BAUR, Schondorf (DE); Gerd SCHWEINITZER, Frankfurt am Main (DE); Martin BAUER, Eppstein (DE)

(73) Assignee: Clariant International Ltd., Muttenz (CH)

(21) Appl. No.: 16/966,290

(22) PCT Filed: Jan. 14, 2019
(86) PCT No.: PCT/EP2019/050825

§ 371 Date: Jul. 30, 2020

(30) Foreign Application Priority Data
Feb. 1, 2018 (DE) 10 2018 201 551.1

(51) Int. Cl. A01N 57/20; A01N 25/30; A01N 25/02

(52) U.S. Cl. CPC A01N 57/20; A01N 25/02; A01N 25/30

(57) ABSTRACT

The invention relates to compositions comprising a) water-soluble herbicide, b) one or more n-alkylglucamides of the formula (I), formula (II),

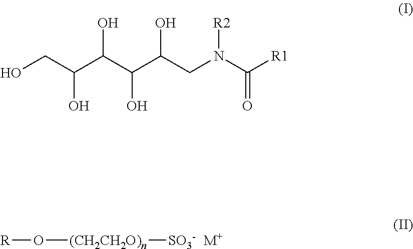

wherein R1 represents a linear or branched alkyl group having 5 to 9 carbon atoms, R2 represents an alkyl group having 1 to 3 carbon atoms, c) one or more alkyl ether sulfates having 1 to 10 c atoms in the alkyl chain and having 1 to 20 alkyleneoxy units in the ether moiety, and water. The compositions according to the invention are highly effective and are characterised by a very advantageous toxicological and ecological profile, and also by having good storage stability whilst having a uniform and high biological activity.

The invention relates to the combined use of selective glucamides and selected low-foam or foam-free alkyl ether sulfates for production of formulations comprising water-soluble herbicides alone, together with one another or in combination with further active ingredients. The mixtures show a multiple synergistic effect in relation to wetting action and biological action for control of weeds compared to the same amount of the individual components. Moreover, spray liquors containing the alkyl ether sulfates used in accordance with the invention in combination with the glucamides used in accordance with the invention have a smaller proportion of fine droplets than corresponding products containing the lauryl ether sulfates that are considered to be the market standard, such as Genapol® LRO.

Water-soluble herbicides, for example glufosinate, are chemical substances that penetrate into plant cells or tissue or into parasitic organisms in or on the plant and damage and/or destroy them. Formulations containing water-soluble herbicides are typically used in the form of liquid or solid concentrated formulations that facilitate user handling or ensure a higher efficacy of the active ingredient. The formulations are typically diluted with water prior to use and then deployed by spray application.

Water-soluble concentrates (soluble liquids, abbreviated to SL) are a particularly important form of herbicide formulations, wherein the active ingredient is often used in the form of a water soluble salt which is obtained by neutralizing the acid form of the herbicide with suitable bases.

A general problem affecting the application of active agrochemical ingredients is that only a fraction of the active ingredient develops the desired activity. By far the greatest portion is often lost unutilized, in that the active ingredient does not reach the leaves or roots of the plant on deployment of the spray liquor, but seeps away unutilized in the soil, is washed away by rain or is simply not absorbed by the plant.

This environmental and economic disadvantage can be reduced by addition of auxiliaries (adjuvants) to active ingredient formulations. These adjuvants are able, for example, to improve wetting of the plant, or to ensure that the active ingredient adheres longer to the plant surface and/or is better absorbed.

Especially in the case of water-soluble active ingredients, as in the case of glufosinate, the type and amount of the adjuvants used have a crucial influence on the efficacy of the formulation. Aqueous formulations of glufosinate-ammonium are known, for example, from EP-A-0048436, EP-A-0336151, EP-A-1093722 or WO 2007/147500 A1. Preference is given here to using alkyl ether sulfates.

Commercially available formulations have to date used alkyl ether sulfates having a C₁₂-C₁₆ alkyl chain length and containing 1 to 10 ethyleneoxy units as adjuvants. These are suitable for boosting the biological effect of glufosinate when applied to the green parts of plants. The exact mechanism of action of alkyl ether sulfates here is unknown. The exceptional suitability of alkyl ether sulfates in boosting the effect of glufosinate derives from a combination of favorable properties of alkyl ether sulfates. Other adjuvants having comparable surfactant properties (for example adherence of spray mist or spread on target plants), including all adjuvants for herbicides described in the “Compendium of Herbicide Adjuvants” (www.herbicide-adjuvants.com, 2014), result in a weaker effect compared to said alkyl ether sulfates. Substances with solvent character, such as polyether glycols, glycerol, mineral oils, mineral oil concentrates, polymers, buffers, and other substances, are likewise not characterized by a comparable effect. The sole nonionic surfactants that are used in commercial formulations (e.g. Liberty®, from Bayer, EPA Reg. No. 264-829) are sugar-based alkyl polyglycosides. However, in order to avoid reducing the effect of the glufosinate formulation, these are used only in combination with the abovementioned alkyl ether sulfates.

Owing to the C₁₂-C₁₆-alkyl ether sulfates of the type mentioned that are present in glufosinate formulations customary on the market, the formulations, prior to application on dilution with water and during application in the case of spraying, show unfavorable foaming characteristics. This can lead to overflows of the spraying apparatus, environmental contamination, irregular spray deposits on the plants and residues of crop protection compositions in the spraying apparatus.

In addition to the unfavorable foaming characteristics, glufosinate formulations containing C₁₂-C₁₆-alkyl ether sulfates that are customary on the market are known to have further disadvantageous properties.

From an economic point of view, maximum active ingredient loadings are desirable for crop protection formulations. However, the maximum active ingredient loading for aqueous formulations of glufosinate-ammonium using the abovementioned C₁₂-C₁₆-alkyl ether sulfate as adjuvant is limited to <300 g/l a.e.

It is also known that the abovementioned C₁₂-C₁₆-alkyl ether sulfates have an antagonistic effect on the action of other herbicides, for example glyphosate. Therefore, a glufosinate formulations containing C₁₂-C₁₆-alkyl ether sulfates that are customary on the market cannot be combined with glyphosate formulations in the spray liquor.

According to WO 2007/147500 A1, selected 01-09-alkyl ether sulfates having 1-20 alkyleneoxy units in the ether moiety are suitable for production of low-foam formulations containing water-soluble active agrochemical ingredients.

A useful nonionogenic class of surfactants having a similar combination of properties to alkyl ether sulfates is that of sugar-based surfactants such as alkyl-N-methylglucosamides.

WO-A-96/16540 describes pesticide compositions comprising long-chain alkylamides that bear a polyhydroxycarbonyl substituent having at least three hydroxyl groups on the amide nitrogen. The examples describe emulsifiable concentrates, water-dispersible powders and granules of dodecyl-N methylglucamide, dodecyltetradecyl-N-methylglucamide, and cetylstearyl-N methylglucamide.

Compositions containing glufosinate and selected sugar-based N-alkylglucamides are known from WO 2016/050782 A1.

For the reasons mentioned, there is a need for alternative solutions that enable the production of high-load, low-foaming aqueous formulations containing water-soluble herbicides, especially containing glufosinate, and combinability with further agrochemical water-soluble active ingredients having high activity, which feature a very advantageous toxicological and environmental profile, and promote the enhancement of the uptake of systemic active ingredients, wetting and solubilization, and enable combinability with ammonium sulfate and other (active) electrolyte ingredients and have advantageous properties from a performance point of view, for example good storage stability and uniform and high biological efficacy. Moreover, spray liquors containing the alkyl ether sulfates used in accordance with the invention in combination with the glucamides used in accordance with the invention have a smaller proportion of fine droplets than corresponding products containing the lauryl ether sulfates that are considered to be the market standard, such as Genapol® LRO.

Surprisingly, the above-described need for alternative solutions for water-soluble herbicides, and especially for glufosinate-containing compositions, is fulfilled very efficiently by the compositions described hereinafter that additionally contain selected alkyl ether sulfates in addition to selected N-alkylglucosamides.

In the production of aqueous formulations containing water-soluble herbicides with selected alkyl ether sulfates, it has been found that, surprisingly, adequate phase stability can be achieved when selected N-alkylglucamides are additionally present as well as water. Under these conditions, it is possible to provide storage-stable formulations. After appropriate dilution, the formulations can be deployed on the plants to be treated in the form of spray liquors.

It has been found that, surprisingly, this can achieve a high efficacy of the water-soluble herbicide. The mixtures surprisingly show a multiple synergistic effect in relation to wetting action and biological action for control of weeds compared to the same amount of the individual components. Moreover, spray liquors comprising the alkyl ether sulfates used in accordance with the invention, in combination with the glucamides used in accordance with the invention, have a smaller fine droplet content.

The invention relates to compositions comprising
a) a water-soluble herbicide,
b) N-alkylglucamide of the formula (I)

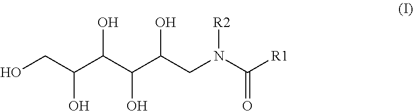

in which
R1 is a linear or branched alkyl group having 5 to 9 carbon atoms,
R2 is an alkyl group having 1 to 3 carbon atoms,
c) alkyl ether sulfate having 1 to 10 carbon atoms, preferably having 6 to 10 carbon atoms and most preferably having 8 to 10 carbon atoms in the alkyl chain and having 1 to 20, preferably 2 to 10 and most preferably 3 to 5 alkyleneoxy units in the ether moiety, and
d) water.

Preferred compositions of the invention may, as well as the abovementioned components a) to d), additionally comprise

as component e) a cosolvent selected from the group consisting of dihydric and trihydric alcohols, and/or

as component f) further active agrochemical ingredient, and/or

as component g) water-soluble macro- and/or micronutrients, especially nitrogen-containing inorganic salts and/or urea and/or urea derivatives, and/or

as component h) further surfactant other than components b) and d), and/or

as component i) further customary formulation auxiliaries.

Water-soluble herbicides in the context of the invention are understood to mean herbicides having a solubility in water at room temperature (25° C.) of more than 5% by weight and preferably of more than 10% by weight.

The same applies to other water-soluble active agrochemical ingredients, such as pesticides or insecticides.

The active agrochemical ingredient of component a) preferably comprises water-soluble acids or salts of auxins, of glufosinate, or of glyphosate, alone, together with one another or in combination with further active ingredients of component f).

More preferably, the active agrochemical ingredient of component a) is glufosinate and especially comprises water-soluble salts of glufosinate and most preferably glufosinate-ammonium.

In the context of the present invention, “further active agrochemical ingredients” (component f) are understood to mean pesticides other than the active agrochemical ingredients of component a), such as acaricides, bactericides, fungicides, herbicides, insecticides, molluscicides, nematicides and rodenticides, and also phytohormones, such as crop growth regulators, and also safeners. Phytohormones control physiological reactions, such as growth, flowering rhythm, cell division and seed ripening. An overview of the most relevant pesticides can be found, for example, in “The Pesticide Manual” from the British Crop Protection Council, 16th Edition 2012, editor: C. MacBean. Explicit reference is hereby made to the active ingredients listed therein. They are incorporated into this description by citation.

The one or more further active agrochemical ingredients that may be present in the compositions of the invention as component f) are preferably selected from the group consisting of fungicides, herbicides, insecticides, or are preferably safeners or crop growth regulators or combinations of two or more of these active ingredients. Preference is given to herbicides.

In a further preferred embodiment, the further pesticides of component f) are not herbicides, and are, for example, insecticides from the group of the chloronicotinyls, such as thiomethoxam, or growth regulators, such as chlormequat chloride.

Particularly preferred herbicides are acifluorfen, aminopyralid, amitrole, asulam, benazolin, bentazon, bialaphos, bispyribac, bromacil, bromoxynil, bicyclopyron, chloramben, clethodim, clopyralid, 2,4-D, 2,4-DB, dicamba, dichlorprop, difenzoquat, diflufenzopyr, diquat, dimethenamid-p, endothal, fenoxaprop, flamprop, flumiclorac, fluoroglycofen, fomesafen, fosamine, glyphosate, imizameth, imazamethabenz, imazamox, imazapic, imazapyr, imazaquin, imazethapyr, isoxadifen, isoxaflutole, MCPA, MCPB, mecoprop, octanoic acid, paraquat, pelargonic acid, picloram, pyroxasulfone, quinclorac, quizalofop, saflufenacil, 2,3,6-TBA, triclopyr, topramezon and trifludimoxazin preferred.

Among the salts of active agrochemical ingredients, and of pesticides in particular, preference is given especially to the alkali metal and ammonium salts, and among these in turn to the potassium, ammonium, dimethylammonium, isopropylammonium, diglycolammonium, and (2-hydroxyethyl)trimethylammonium salts.

The exact chemical composition and structure of all these compounds are known and available on the Internet at: http://www.alanwood.net/pesticides/index_cn_frame.html

The compositions of the invention in the form of concentrates preferably contain 1% to 80% by weight, more preferably 10% to 35% by weight, especially 15% to 30% by weight, of the agrochemical herbicide of component a). The amounts given here are based on the total weight of the composition. The amounts of component a) can of course be correspondingly lowered by dilution prior to application.

The compositions of the invention in the form of concentrates preferably contain 1% to 80% by weight, more preferably 2% to 30% by weight, especially preferably 5% to 20% by weight, of the one or more further agrochemical active ingredients as component f). The amounts given here are based on the total weight of the composition. The amounts of component(s) f) can of course be correspondingly lowered by dilution prior to application.

More preferably, the compositions of the invention contain 18% to 40% by weight and preferably 25% to 40% by weight of the active agrochemical ingredient of component a) and no further active agrochemical ingredients of component f).

The further active agrochemical ingredients f) optionally present are preferably pesticides, and most preferably 2,4-D, bentazon, clethodim, clopyralid, dicamba, fomesafen, glyphosate, imazamox, imazapyr, imazethapyr, isoxadifen, isoxaflutole, MCPA, paraquat, saflufenacil, dimethenamid-p, pyroxasulfone, quinclorac, diflufenzopyr, trifludimoxazin or topramezone.

The active agrochemical ingredients may also be a combination of two or more active agrochemical ingredients, especially a combination of two or more herbicides or a combination of one or more herbicides with one or more safeners.

Such combinations are of particular significance when the aim is, for example, to broaden the spectrum of action of a formulation containing one or more herbicides or to better prevent resistances to particular herbicides.

The combination of two or more active agrochemical ingredients in a formulation, especially an aqueous formulation, is a difficult task since the active ingredients are typically not compatible with one another and the mixtures are not phase-stable. However, the alkylglucamides of the formula (I) in combination with the alkyl ether sulfates described are of excellent suitability for stabilizing such fundamentally incompatible compositions.

With the above-described alkylglucamides of the formula (I) as component b) in combination with the alkyl ether sulfates of component c), it is possible to produce aqueous herbicide formulations of the invention with excellent performance properties.

In the one or more alkylglucamides of the formula (I), the R1 radical is preferably a linear or branched alkyl group having 7 to 9 carbon atoms. The R2 radical is preferably a methyl group.

More preferably, the compositions of the invention comprise a mixture of octanoyl-N-methylglucamide (R1=C₇ alkyl, R2=methyl) and decanoyl-N-methylglucamide (R1=C₉ alkyl, R2=methyl). The proportion of octanoyl-N-methylglucamide in this mixture is 10% to 90% by weight, preferably 20% to 80% by weight and more preferably 30% to 70% by weight, based on the total amount of the alkylglucamides present in this mixture. The proportion of decanoyl-N-methylglucamide in this mixture is 10% to 90% by weight, preferably 20% to 80% by weight and more preferably 30% to 70% by weight, based on the total amount of the alkylglucamides present in this mixture.

The pentahydroxyhexyl radical in the alkylglucamides of the formula (I) has various chiral centers, such that several stereoisomers can exist in each case. Typically, the alkylglucamides of the formula (I) are prepared from naturally occurring sugars, such as D-glucose, but the use of other natural or synthetic hexoses or other C₆ units is also possible in principle, such that different stereoisomers of the formula (I) can result.

The alkylglucamides of the formula (I) are preferably based on renewable raw materials and feature an advantageous toxicological and ecological profile. They have high solubility in water.

The preparation of alkylglucamides of the formula (I) has been described in sufficient detail in, for example, EP-A-550,637 and is known to those skilled in the art. It is achieved, for example, by condensation of carboxylic esters with a secondary N-alkylglucamine, which can in turn be prepared from a sugar such as D-glucose by reductive amination.

Typically, the alkylglucamides of the formula (I) are used in the form of solutions. For clarification, it should be mentioned here that the amounts given above are based on the active content in the solution of alkylglucamides of the formula (I).

For better handling, the alkylglucamides of the formula (I) are typically used in the form of aqueous solutions containing 10% to 90% by weight, more preferably 20% to 80% by weight, and especially preferably 30% to 70% by weight of the one or more alkylglucamides of component b). As a consequence of the manufacturing process, these adjuvant compositions may additionally contain one or more cosolvents e) as a secondary component. For clarification, it should be mentioned here that the amounts given above are based on the active content in the solution of alkylglucamides of the formula (I).

The compositions of the invention in the form of concentrates preferably contain 0.1% to 97% by weight, more preferably 1% to 80% by weight, especially preferably 5% to 60% by weight, of the one or more alkylglucamides of the formula (I) of component b). The amounts given here are based on the total weight of the composition. The amounts of component b) can of course be correspondingly lowered by dilution prior to application.

Component c) used in accordance with the invention comprises alkyl ether sulfates having 1 to 10 carbon atoms in the alkyl chain and having 1 to 20 alkyleneoxy units in the ether moiety, preferably having 2 to 10 and especially having 3 to 5 alkyleneoxy units in the ether moiety. Preferred alkyl ether sulfates have 6 to 10 and especially 8 to 10 carbon atoms in the alkyl chain. The term “alkyl ether sulfates” is understood to mean compounds from the group of the (C₁-C₁₀)-alkyl (poly)glycol ether sulfates that generally have a terminal sulfate group. The (C₁-C₁₀)-alkyl (poly)glycol ether sulfates used in accordance with the invention may have 1 to 20 identical or different C₁-C₄-alkyleneoxy units and preferably contain an alkyleneoxy group esterified with the sulfate group in a terminal position.

The (poly)alkyleneoxy group may contain identical or different alkyleneoxy units, for example C₁-C₄-alkyleneoxy units such as 1,2-ethyleneoxy [—CH₂CH₂—O—], also referred to as “ethyleneoxy group” or “EO” for short, 1,2-propyleneoxy [—CH(CH₃)CH₂—O—], 2,3-propyleneoxy [—CH₂CH(CH₃)—O—], 1,2-butyleneoxy [—CH₂CH(C₂H₅)—O—], 2,3-butyleneoxy [—CH(CH₃)CH(CH₃)—O—], 3,4-butyleneoxy [—CH(C₂H₅)CH₂—O—], 1,1-dimethyl-1,2-ethyleneoxy [—C(CH₃)₂CH₂—O-] and 2,2-dimethyl-1,2-ethyleneoxy [—CH₂C(CH₃)₂—O—].

Preference is given here to (poly)alkyleneoxy groups containing a 1,2-alkyleneoxy group terminally esterified with the sulfate group; in particular, the last alkyleneoxy unit in the polyalkyleneoxy group here that bears the sulfate group is an EO unit.

Component c) is more preferably (C₈-C₁₀)-alkyl (poly)ethylene glycol ether sulfates with 2 to 10 EO, preferably 3 to 5 EO.

The alkyl radicals in the (C₁-C₁₀)-alkyl group may be straight-chain or branched.

The alkyl ether sulfates are anionic surfactants. The counterions in these anionic compounds may generally be any cations usable in agriculture, for example alkali metal cations, such as sodium or potassium, alkaline earth metal cations, such as magnesium or calcium, ammonium or organically substituted ammonium ions, such as alkylammonium, dialkylammonium, trialkylammonium, e.g. trimethylammonium or isopropylammonium. Also useful are other cationic groups such as the trimesium ion (known from sulfosate) or alkoxylated ammonium ions.

Suitable alkyl ether sulfates are, for example, octyl (poly)glycol ether sulfate, nonyl (poly)glycol ether sulfate, decyl (poly)glycol ether sulfate, including (poly)glycol ether moieties having 1 to 20 alkylene glycol units in each case, and preferably the (poly)alkylene glycol groups specified as preferred.

Further preferred are the (poly)glycol ether moieties composed of 3 to 5 ethyleneoxy units (more specifically 1,2-ethyleneoxy units). The counterions are preferably sodium, potassium and ammonium ions.

Preferred alkyl ether sulfates of component c) are compounds of the formula (II)

R—O—(CH₂CH₂O)ₙ-SO₃⁻M⁺ (II)
in which
R denotes a C₈-C₁₀-alkyl group,
n is an integer from 2 to 10, especially from 3 to 5, that denotes the number of ethyleneoxy groups in the (poly)ethyleneoxy bridge, and
M denotes a monovalent cation, preferably H⁺ or a monovalent metal ion or an ammonium ion.

Particularly preferred alkyl ether sulfate compounds include octyl ethylene glycol ether sulfate, octyl diethylene glycol ether sulfate, octyl triethylene glycol ether sulfate, octyl tetraethylene glycol ether sulfate, octyl pentaethylene glycol ether sulfate, octyl hexaethylene glycol ether sulfate, octyl heptaethylene glycol ether sulfate, octyl octaethylene glycol ether sulfate, octyl nonaethylene glycol ether sulfate, octyl decaethylene glycol ether sulfate, nonyl ethylene glycol ether sulfate, nonyl diethylene glycol ether sulfate, nonyl triethylene glycol ether sulfate, nonyl tetraethylene glycol ether sulfate, nonyl pentaethylene glycol ether sulfate, nonyl hexaethylene glycol ether sulfate, nonyl heptaethylene glycol ether sulfate, nonyl octaethylene glycol ether sulfate, nonyl nonaethylene glycol ether sulfate, nonyl decaethylene glycol ether sulfate, decyl ethylene glycol ether sulfate, decyl diethylene glycol ether sulfate, decyl triethylene glycol ether sulfate, decyl tetraethylene glycol ether sulfate, decyl pentaethylene glycol ether sulfate, decyl hexaethylene glycol ether sulfate, decyl heptaethylene glycol ether sulfate, decyl octaethylene glycol ether sulfate, decyl nonaethylene glycol ether sulfate, and decyl decaethylene glycol ether sulfate, where, as well as the H form, preference is given in each case to any salts and mixtures thereof, further preferably the alkali metal salts thereof with M⁺=an alkali metal cation or ammonium salts with preferably M⁺=NH₄⁺ as counterion are useful, and where preference is given specifically to the sodium salts, potassium salts or ammonium salts thereof, especially the sodium salts thereof.

Particular preference is also given to mixtures of sodium and potassium and/or ammonium salts of the alkyl ether sulfates of the abovementioned individual compounds.

Among the additives c) mentioned, particular preference is given to those having linear alkyl radicals.

The compounds are commercially available and can be prepared by methods known to the person skilled in the art.

The compositions of the invention in the form of concentrates preferably contain 0.1% to 97% by weight, more preferably 1% to 80% by weight, especially preferably 5% to 60% by weight, of the one or more alkyl ether sulfates of component c). The amounts given here are based on the total weight of the composition. The amounts of component c) can of course be correspondingly lowered by dilution prior to application.

The compositions of the invention in the form of concentrates preferably contain 0.01% up to 95% by weight of water (component d)), preferably 0.1% to 90% by weight, more preferably 5% to 85% by weight and most preferably 10% to 60% by weight. The amounts given here are based on the total weight of the composition. The amount of component d) may of course be correspondingly lower prior to application by dilution with water.

The one or more cosolvents e) optionally present may either be present as a secondary component from the process of preparing the alkylglucamide and/or have been added subsequently to the composition. The one or more cosolvents may comprise a single dihydric or trihydric alcohol or a mixture of two or more such alcohols.

In the case of single-phase aqueous-organic solutions, the completely or largely water-miscible dihydric or trihydric alcohols or alcohol mixtures are suitable.

Suitable cosolvents are dihydric or trihydric alcohols, such as ethylene glycol, diethylene glycol, propylene glycol, glycerol or polyglycols, such as polyethylene glycol, polypropylene glycol or mixed polyalkylene glycols (PAGs), and most preferably glycerol, propylene glycol, and dipropylene glycol.

The cosolvent, for example, increases cold or heat stability and/or has a positive influence on further performance properties such as viscosity. Moreover, glycerol and ethylene glycols in particular act as humectants, which has a positive effect on the properties of the spray coating.

The proportion of cosolvent(s) in the composition of the invention in the form of concentrates is typically up to 30% by weight, preferably 1% to 25% by weight, and more preferably 2% to 20% by weight. The amounts given here are based on the total weight of the composition. The amounts of component(s) e) can of course be correspondingly lowered by dilution prior to application.

By virtue of the high salt stability of the alkylglucamides of the formula (I) used in the composition of the invention in combination with the alkyl ether sulfates of component c) in an aqueous medium, even in the case of a high active ingredient and salt concentration, it is possible to produce agrochemical herbicide formulations having high salt stability, which constitutes a major performance advantage. This also enables incorporation of water-soluble macro- and/or micronutrients, such as nitrogen-containing fertilizers, for example inorganic ammonium salts, into the compositions.

The one or more water-soluble macro- and/or micronutrients are compounds that supply the plant with essential elements.

Examples of macronutrients are compounds that supply the plant with nitrogen, phosphorus or potassium.

Examples of micronutrients are compounds that supply the plant with boron, chlorine, copper, iron, manganese, molybdenum or zinc.

Preferred components g) are nitrogen-containing salts, such as fertilizers or else salts that are used for the conditioning of the formulation. Component g) preferably comprises inorganic ammonium salts and/or urea (derivatives). Particular preference is given to one or two inorganic ammonium salts, and very particular preference to one water-soluble inorganic ammonium salt.

Preferred water-soluble inorganic ammonium salts are ammonium sulfate, ammonium nitrate, ammonium nitrate urea, ammonium phosphate, ammonium thiocyanate, ammonium thiosulfate and/or ammonium chloride, more preferably ammonium sulfate, ammonium nitrate and/or ammonium nitrate urea, and most preferably ammonium sulfate.

The proportion of component g) in the compositions of the invention in the form of concentrates is typically 0.01% to 25% by weight, preferably 0.1% to 20% by weight, more preferably 1% to 20% by weight, and most preferably 3% to 15% by weight. The amounts given here are based on the total weight of the composition.

The amounts of component g) can of course be correspondingly lowered by dilution prior to application.

Useful further surfactants for component h) that differ from components b) and d) include anion-active, nonionogenic, cation-active and/or zwitterionic surfactants.

Examples of such surfactants are listed below (where, in each case, EO=ethylene oxide units, PO=propylene oxide units and BO=butylene oxide units from the preparation point of view, or corresponding alkyleneoxy units in the surfactant molecules):

Anion-active surfactants, for example:
1. anionic derivatives of fatty alcohols having 10-24 carbon atoms with 0-60 EO and/or 0-20 PO and/or 0-15 BO in any sequence in the form of ether carboxylates, sulfonates, sulfates and phosphates and the inorganic (e.g. alkali metal and alkaline earth metal) and organic salts (for example based on amine or alkanolamine) thereof, such as Genapol® LRO, Sandopan® products, Hostaphat/Hordaphos® products from Clariant;
2. anionic derivatives of copolymers consisting of EO, PO and/or BO units with a molecular weight of 400 to 10⁸ in the form of ether carboxylates, sulfonates, sulfates and phosphates and the inorganic (e.g. alkali metal and alkaline earth metal) and organic salts (for example based on amine or alkanolamine) thereof;
3. anionic derivatives of alkylene oxide adducts of C₁-C₉ alcohols in the form of ether carboxylates, sulfonates and phosphates and the inorganic (e.g. alkali metal and alkaline earth metal) and organic salts (for example based on amine or alkanolamine) thereof, anionic derivatives of fatty acid alkoxylates in the form of ether carboxylates, sulfonates, sulfates and phosphates and the inorganic (e.g. alkali metal and alkaline earth metal) and organic salts (for example based on amine or alkanolamine) thereof;

Cation-active or zwitterionic surfactants, for example:
1. alkylene oxide adducts of fatty amines, quaternary ammonium compounds having 8 to 22 carbon atoms (C₈-C₂₂), for example the Genamin® C, L, O, T products from Clariant;
2. surface-active zwitterionic compounds such as taurides, betaines and sulfobetaines in the form of Tegotain® products from Goldschmidt, Hostapon® T and Arkopon® T products from Clariant.

Nonionogenic surfactants, for example:
1. fatty alcohols having 8-24 carbon atoms with 0-60 EO and/or 0-20 PO and/or 0-15 BO in any sequence. Examples of such compounds are Genapol® C, L, O, T, UD, UDD, X products from Clariant, Plurafac® and Lutensol® A, AT, ON, TO products from BASF, Marlipal®24 and 013 products from Condea, Dehypon® products from Henkel, Ethylan® products from Akzo-Nobel, such as Ethylan CD 120;
2. fatty acid alkoxylates and triglyceride alkoxylates such as the Serdox®NOG products from Condea or the Emulsogen® products from Clariant;
3. fatty acid amide alkoxylates such as the Comperlan® products from Henkel or the Amam® products from Rhodia;
4. alkylene oxide adducts of alkynediols such as the Surfynol® products from Air Products; sugar derivatives such as amino and amido sugars from Clariant;
5. glucitols from Clariant;
6. silicone- or silane-based surface-active compounds such as the Tegopren® products from Goldschmidt and the SE® products from Wacker, and the Bevaloid®, Rhodorsil® and Silcolapse® products from Rhodia (Dow Corning, Reliance, GE, Bayer),
7. interface-active sulfonamides, for example from Bayer;
8. interface-active polyacryloyl and polymethacryloyl derivatives such as the Sokalan® products from BASF;
9. surface-active polyamides such as modified gelatin or derivatized polyaspartic acid from Bayer and derivatives thereof,
10. surfactant polyvinyl compounds such as modified PVP, such as the Luviskol® products from BASF and the Agrimer® products from ISP, or the derivatized polyvinyl acetates such as the Mowilith® products from Clariant or the polyvinyl butyrates such as the Lutonal® products from BASF, the Vinnapas® and the Pioloform® products from Wacker or modified polyvinyl alcohols such as the Mowiol® products from Clariant,
11. surface-active polymers based on maleic anhydride and/or reaction products of maleic anhydride and maleic anhydride and/or reaction products of maleic anhydride-containing copolymers such as the Agrimer®-VEMA products from ISP;
12. surface-active derivatives of montan waxes, polyethylene waxes and polypropylene waxes, such as the Hoechst® waxes or the Licowet® products from Clariant;
13. polyol-based alkylene oxide adducts such as Polyglykol® products from Clariant;
14. interface-active polyglycerides and derivatives thereof from Clariant;
15. alkyl polysaccharides and mixtures thereof, for example from the Atplus® series from Uniqema, preferably Atplus 435,
16. alkyl polyglycosides in the form of the APG® products from Henkel, for example Plantaren® APG 225 (fatty alcohol C₈-C₁₀-glucoside),
17. sorbitan esters in the form of the Span® or Tween® products from Uniqema,
18. cyclodextrin esters or ethers from Wacker,
19. surface-active cellulose and algin, pectin and guar derivatives such as the Tylose® products from Clariant, the Manutex® products from Kelco and guar derivatives from Cesalpina,
20. alkyl polyglycoside/alkyl polysaccharide mixtures based on C₈-C₁₀ fatty alcohol, such as Glucopon® 225 DK and Glucopon® 215 CSUP (BASF);

The compositions of the invention in the form of concentrates preferably contain up to 25% by weight, more preferably up to 20% by weight, especially preferably 1% to 20% by weight, and most preferably 3% to 15% by weight of one or more surfactants of component h). The amounts given here are based on the total weight of the composition. The amounts of component h) can of course be correspondingly lowered by dilution prior to application.

The compositions of the invention may optionally comprise further customary formulation auxiliaries as component i). Examples of these are solvents, inert materials such as stickers, wetters, dispersants, emulsifiers, penetrants, preservatives, fillers, carriers and dyes, and agents that affect the pH (buffers, acids and bases) or the viscosity (e.g. thickeners), and optionally also defoamers, although the latter are advisable in a reduced amount at most. Customary formulation auxiliaries i) are, for example, said inert materials, evaporation inhibitors, preservatives and/or dyes.

Preferably, the compositions of the invention comprise defoamers, dyes and agents that affect the pH as formulation auxiliaries i).

Possible components i) are, for example, polar or nonpolar organic solvents or polar or nonpolar inorganic solvents or mixtures thereof. Moreover, the compositions of the invention contain water as component e).

Examples of nonpolar solvents in the context of the invention are
aliphatic or aromatic hydrocarbons, for example mineral oils or toluene, xylenes and naphthalene derivatives,
halogenated aliphatic or aromatic hydrocarbons, such as methylene chloride or chlorobenzene,
oils, for example vegetable-based oils such as corn kernel oil and rapeseed oil, or oil derivatives such as rapeseed oil methyl ester.

Examples of polar solvents in the context of the invention are
polar ethers such as tetrahydrofuran (THF), dioxane, alkylene glycol monoalkyl ethers and dialkyl ethers, for example propylene glycol monomethyl ether, propylene glycol monoethyl ether, ethylene glycol monomethyl ether or monoethyl ether, diglyme and tetraglyme;
amides such as dimethylformamide (DMF), dimethylacetamide, dimethylcaprylamide, dimethylcaprinamide (Hallcomide®) and N-alkylpyrrolidones;
ketones such as acetone;
esters based on glycerol and carboxylic acids, such as glycerol mono-, di- and triacetate,
lactams,
lactate esters having chain lengths of 1 to 10 carbon atoms in the ester moiety,
carbonic esters;
nitriles such as acetonitrile, propionitrile, butyronitrile and benzonitrile;
sulfoxides and sulfones such as dimethyl sulfoxide (DMSO) and sulfolane.

Also frequently suitable are combinations of different solvents, which additionally include alcohols such as methanol, ethanol, n- and isopropanol, and n-, iso-, tert- and 2-butanol.

The compositions of the invention may optionally comprise defoamers as component i). The defoamers may be a single defoamer or a mixture of two or more defoamers. Suitable defoamers are fatty acid alkyl ester alkoxylates, organopolysiloxanes such as polydimethylsiloxanes and mixtures thereof with microfine, optionally silanized silica, perfluoroalkylphosphonates, perfluoroalkylphosphinates, paraffins, waxes and microcrystalline waxes, and mixtures thereof with silanized silica. Also advantageous are mixtures of various foam inhibitors, for example those of silicone oil, paraffin oil and/or waxes.

The compositions of the invention may optionally comprise preservatives as component i). The preservatives may be a single preservative or a mixture of two or more preservatives. Preservatives used may be organic acids and esters thereof, for example ascorbic acid, ascorbyl palmitate, sorbate, benzoic acid, methyl 4-hydroxybenzoate, propyl 4-hydroxybenzoate, propionates, phenol, 2-phenylphenate, 1,2-benzisothiazolin-3-one, formaldehyde, sulfurous acid and salts thereof. Examples include Mergel K9N® (Riedel) or Cobate C®.

The compositions of the invention may optionally comprise drift retardants as component i). The drift retardants may be a single drift retardant or a mixture of two or more drift retardants. Drift retardants used may be water-soluble polymers, for example polyacrylamides, acrylamide/acrylic acid polymers, sodium polyacrylate, carboxymethyl cellulose, hydroxyethyl cellulose, methyl cellulose, polysaccharides, natural and synthetic guar gum. In addition, it is also possible to use particular emulsions or self-emulsifying systems as drift retardants. An example given here is InterLock® (Winfield).

The compositions of the invention, in the form of concentrates, may contain up to 50% by weight of one or more formulation auxiliaries of component i), preferably up to 20% by weight and more preferably up to 15% by weight. The amounts given here are based on the total weight of the composition. The amounts of component i) can of course be correspondingly lowered by dilution prior to application.

In a preferred embodiment of the invention, the compositions of the invention are in the form of concentrate formulations containing
a) 1% to 80% by weight, preferably 10% to 35% by weight, especially 15% to 30% by weight, of one or more water-soluble herbicides, especially the active agrochemical ingredient glufosinate,
b) 0.1% to 97% by weight, preferably 1% to 80% by weight, especially 2% to 70% by weight, very particularly 5% to 60% by weight, of one or more alkylglucamides of the formula (I),

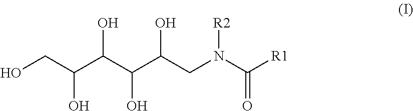

in which
R1 is a linear or branched alkyl group having 5 to 9 carbon atoms,
R2 is an alkyl group having 1 to 3 carbon atoms,
c) 0.1% to 97% by weight, preferably 1% to 80% by weight, especially 2% to 70% by weight, very particularly 5% to 60% by weight, of one or more alkyl ether sulfates having 1 to 10 carbon atoms in the alkyl chain and having 1 to 20 alkyleneoxy units in the ether moiety,
d) 0.01% to 95% by weight, preferably 0.1% to 90% by weight, further preferably 5% to 85% by weight, of water, especially 10% to 60% by weight of water,
e) 0% to 30% by weight, preferably 1% to 25% by weight, especially 2% to 20% by weight, and most preferably 5% to 15% by weight, of one or more di- or trihydric alcohols as cosolvents,
f) 0% to 80% by weight, preferably 10% to 35% by weight, more preferably 15% to 30% by weight, of one or more active agrochemical ingredients,
g) 0% to 25% by weight, preferably 0.1% to 20% by weight, especially 1% to 20% by weight, very particularly 3-15% by weight, of macro- and/or micronutrients, especially nitrogen-containing inorganic ammonium salts and/or urea (derivatives),
h) 0% to 25% by weight, preferably 0% to 20% by weight, especially 1% to 20% by weight, very particularly 3-15% by weight of further surfactants other than the surfactants of components b) and d), and
i) 0% to 50% by weight, preferably 0% to 20% by weight, preferably 0% to 15% by weight, of further customary formulation auxiliaries.

“% by weight” in each case means “percent by weight”, i.e. the ratio of weight of the constituent and weight of the formulation in percent. Preference is also given to compositions in which the content of the components consists of a combination of two or more of the proportions of the components that are specified as preferred.

In a preferred embodiment of the invention, the amount of the one or more active agrochemical ingredients of component a) in the compositions of the invention is more than 10% by weight, preferably more than 20% by weight and more preferably more than 30% by weight. These figures are based on the entire composition of the invention and, in the case of active agrochemical ingredients that are used in the form of their salts (such as typically glufosinate, dicamba, glyphosate or 2,4-D, for example), on the amount of free acid, called the acid equivalent (a.e.).

An important criterion for the storage stability of aqueous formulations of active agrochemical ingredients, such as pesticide formulations, e.g. glufosinate, glyphosate, dicamba and 2,4-D formulations, is phase stability. A formulation is regarded as having sufficient phase stability when it remains homogeneous over a wide temperature range and there is no formation of two or more separate phases or precipitates (formation of a further solid phase). Phase stability is the crucial prerequisite for a storage-stable formulation both at elevated temperature, as can occur, for example, in the case of storage in the sun or in warm countries, and at low temperature, for example in winter or in cold climatic regions.

It is a feature of the compositions of the invention that they are phase-stable both at elevated temperatures, preferably at temperatures of greater than 55° C., and at low temperatures, preferably at temperatures of less than 10° C., more preferably of less than 0° C. and especially preferably of less than −10° C.

The pH of the compositions is typically within the range from 3.5 to 8.0, preferably 4.0 to 7.0 and more preferably 4.5 to 6.5 (measured as a 1% by weight aqueous dilution). The pH is determined primarily by the pH values of the solutions of the aqueous pesticides, which take the form of salts of weak acids. By adding acids, bases or buffer salts, it is possible to adjust the pH to another value different than the original pH of the mixture.

The production of the compositions of the invention is sufficiently well known to the person skilled in the art, and the auxiliaries necessary for production of the compositions of the invention, such as surfactants in particular, are known in principle and are described, for example, in: McCutcheon's “Detergents and Emulsifiers Annual”, MC Publ. Corp., Ridgewood N.J.; Sisley and Wood, “Encyclopedia of Surface active Agents”, Chem. Publ. Co. Inα, N.Y. 1964; Schönfeldt, “Grenzflächenaktive Äthylenoxidaddukte” [Interface-Active Ethylene Oxide Adducts], Wiss. Verlagsgesellschaft, Stuttgart 1976; Winnacker-Küchler, “Chemische Technologie” [Chemical Technology], volume 7, C. Hanser-Verlag, Munich, 4th edition 1986, and literature cited in each.

The liquid formulations of the invention may be produced by methods that are customary in principle, i.e. by mixing the components while stirring or agitating, or by means of static mixing methods. The liquid formulations obtained are stable with good storage qualities.

The compositions of the invention can be produced by mixing components a) to d) and any further components e)-i) that are present in the composition with one another.

The compositions of the invention are preferably used in spray liquors or in formulations intended for production of spray liquors, where the active agrochemical ingredients, especially the pesticides, are preferably wholly or partly water-soluble in the spray liquors, i.e. are generally dissolved in the spray liquor to an extent of 1 to 100 percent by weight, preferably 5 to 100 percent by weight, further preferably to an extent of 10 to 100 percent by weight, especially to an extent of 20 to 100 percent by weight, very particularly to an extent of 30 to 100 percent by weight, based on the weight of the active agrochemical ingredient, preferably at the concentrations of the active ingredients that are customary in practice.

The active ingredients may be used either in individual formulations or in a co-formulation of active agrochemical ingredients or as an addition to tankmixes. Owing to their surface-active properties, the alkylglucamides of component b) and the alkyl (poly)ether sulfates of component c) accelerate the uptake of the one or more active agrochemical ingredients into the plant, especially uptake via the leaf of the plant, and hence contribute to better action of the active ingredients.

The compositions of the invention can thus be used to produce formulations that result in accelerated uptake of water-soluble herbicides, especially of glufosinate, into a plant, especially via the leaf of a plant.

Surprisingly, the surface-active properties of the combination of the surfactants of components b) and c) used in accordance with the invention result in favorable improvements in action with a significantly reduced tendency of the formulations or spray liquors to foam.

The compositions of the invention can thus be used for production of active agrochemical ingredients of component a), especially of glufosinate-containing formulations with a reduced tendency to foaming.

The amount of alkylglucamides of component b) and alkyl (poly)ether sulfates of component c) in the compositions is appropriately chosen such that formulation of the spray liquors results in a non-foaming or comparatively low-foaming spray liquor.

The weight ratio of the active chemical ingredient(s) of component a) and optionally f) (based on 100% active agrochemical ingredient) to alkylglucamides of the formula (I) may vary within wide ranges and is preferably in the range from 1:0.1 to 1:10, especially 1:0.5 to 1:5.

The weight ratio of the active agrochemical ingredient(s) of component a) and optionally f) (based on 100% active agrochemical ingredient) to alkyl (poly)ether sulfates of component c) may likewise vary within wide ranges and is preferably in the range from 1:0.1 to 1:10, especially 1:0.5 to 1:5.

The weight ratio of the alkylglucamides of component b) to the alkyl (poly)ether sulfates of component c) may likewise vary within wide ranges and is preferably in the range from 1:0.1 to 1:10, especially 1:0.5 to 1:5. Most preferred is the range from 3:1 to 1:3.

The liquid formulations containing one or more active agrochemical ingredients are low-foaming and storable. In application, they generally have very favorable technical qualities in many cases. For example, the formulations are distinguished by a low tendency to foam on dilution with water, as for example in the production of tankmixes or in the use of the formulations by the spraying method. The pesticide formulations of the invention, on application, also have comparatively very good biological action when the action is compared with the action of the known formulations with long chain alkyl ether sulfates (for example with the commercial Ignite SL 280 or Basta formulation from Bayer).

The compositions of the invention are preferably deployed to the fields in the form of spray liquors. The spray liquors are produced by diluting concentrate formulations with a defined amount of water.

In a further preferred embodiment of the invention, the compositions of the invention are in the form of spray liquors and contain
0.001% to 10% by weight, preferably 0.02% to 3% by weight and more preferably 0.025% to 2% by weight of glufosinate,
0.001% to 10% by weight, preferably 0.02% to 3% by weight and more preferably 0.025% to 2% by weight of the one or more further pesticides of component f).

The figures given are based on the overall spray liquor and, in the case of active agrochemical ingredients that are used in the form of their salts, on the amount of free acid, called the acid equivalent (a.e.).

The invention further relates to the use of the compositions of the invention for control and/or abatement of weeds, fungal diseases or insect infestation in plants. Preference is given to the use of the compositions of the invention for control and/or abatement of weeds.

The combinations of the invention are of very good suitability for abatement of unwanted plant growth both on uncultivated land and in tolerant crops.

In the case of employment of selective herbicides of component a) and optionally of component f) or of insecticides, fungicides or fertilizers, the compositions of the invention may be used alone or in combination as low-foam and high-performance formulations in the monocotyledonous and dicotyledonous crops that are customary for the active ingredients, for example in economically important crops such as cereals (wheat, barley, triticale, rye, rice, corn, millet/sorghum), sugar beet, sugar cane, oilseed rape, cotton, sunflower, peas, beans and soya. Of particular interest here is employment in monocotyledonous crops such as cereals (wheat, barley, rye, triticale, sorghum), including corn and rice, and monocotyledonous vegetable crops, but also in dicotyledonous crops, for example soya, oilseed rape, cotton, grapes, vegetable plants, fruit plants and/or ornamentals.

The compositions of the invention that may contain one or more active agrochemical ingredients of component a) may be used alone or in combination with other active agrochemical ingredients of component f) and/or nitrogen-containing fertilizers of component g) on uncultivated land, beds of crop plants and/or ornamentals, or in suitable tolerant crops or at suitable junctures in intolerant crops. As well as the tolerant crops of useful plants mentioned, such as the (LibertyLink or Roundup-Ready© crops), for production of field crops, also of interest here are crops for ornamental and useful areas, such as turf. For example, the compositions of the invention with glufosinate(-ammonium), with or without fertilizer, are suitable for employment for control of weed plants in ornamental or useful areas of turf, specifically ryegrass, bluegrass or bermudagrass, preferably specifically in glufosinate-tolerant turf cultures.

### EXAMPLES

The invention is illustrated hereinafter by examples, but these should not be regarded as in any way restrictive.

The percentages stated hereinafter are percentages by weight (% by weight), unless explicitly stated otherwise.

The raw materials used are:

| | |
|---|---|
| Pesticide A | Glufosinate ammonium salt (98% by weight active), |
| | from Schirm |
| Adjuvant A1 | lauryl ether sulfate sodium salt with 2 EO (Genapol |
| | LRO paste, 68% by weight active), from Clariant |
| Adjuvant | alkyl ether sulfate (see example 1, table 1), from |
| A2-A7 | Clariant |
| Adjuvant B | C₈/C₁₀ glucamide (see example 2), from Clariant |
| Cosolvent A | 1,2-propylene glycol, from Clariant |
| Cosolvent B | dipropylene glycol, from Merck |
| Solvent | 1-methoxy-2-propanol, from Alfa Aesar |
| Buffer salt | diammonium hydrogencitrate, from Merck |
| Defoamer | Silicone-based defoamer from Momentive |
| Water | deionized water or tap water |
| Basta | glufosinate-ammonium formulation SL 200 from Bayer |

### Example 1: Preparation of the Alkyl Ether Sulfates (Adjuvant A2-A7)

The alkyl ether sulfates (adjuvant A2-A7 in table 1) were prepared by the following general preparation method: Fatty alcohol ethoxylates were prepared by preparation methods known from the literature (e.g. US-2012/310004) in 1 L stirred autoclaves under sodium hydroxide catalysis. The appropriate alkoxylate was reacted with chlorosulfonic acid in a molar ratio of 1:1 at a reaction temperature of 50° C. at most, and neutralized by addition of a stoichiometric amount of sodium hydroxide. The final product was adjusted to a pH of 7-9.5 and the active ether sulfate content was determined by means of anion-selective titration.

TABLE 1
Overview of the alkyl ether sulfate variants A2-A7 prepared

| | | Active |
|---|---|---|
| | | content % |
| Adjuvant | Alkyl ether sulfate variant | by weight |
| A2 | Octanoyl ether sulfate sodium salt with 3 EO | 68 |
| A3 | Octanoyl ether sulfate sodium salt with 5 EO | 79 |
| A4 | Nonanoyl ether sulfate sodium salt with 3 EO | 54 |
| A5 | Nonanoyl ether sulfate sodium salt with 5 EO | 68 |
| A6 | Decanoyl ether sulfate sodium salt with 3 EO | 46 |
| A7 | Decanoyl ether sulfate sodium salt with 5 EO | 72 |

### Example 2: Preparation of the C₈/C₁₀ Glucamide (Adjuvant B)

The solution with 50% by weight of active 08/010 glucamide substance was produced as follows: First of all, according to EP-A-550 637 C₈/C₁₀ fatty acid methyl ester (methyl octanoate:methyl decanoate=55:45) is reacted with N-methylglucamide in the presence of 1,2-propylene glycol as solvent and obtained as a solid consisting of 90% by weight of active substance and 10% by weight of 1,2-propylene glycol. This solid was dissolved at 40 to 50° C. in water, so as to give a solution with a 50% by weight content of linear 08/010 glucamide. This is a clear colorless solution.

The use concentrations in the examples that follow are always based on the tested product and, with regard to the linear C₈/C₁₀ glucamide itself, what is always meant is a stable solution with 50% by weight active substance content in water/propylene glycol.

### Example 3: Noninventive Aqueous Glufosinate Formulations (Glufosinate-Ammonium 280 and 120 g/l a.e.)

The glufosinate ammonium formulations listed in table 1 were produced by mixing the various components with water. The preparations are then stored for 2 weeks at −10° C., 0° C., 25° C. (room temperature), and 54° C. to determine their storage stability and phase behavior.

TABLE 2
Composition of noninventive aqueous glufosinate formulations

| | R1 | R2 | R3 |
|---|---|---|---|
| Pesticide A¹⁾ | 25.37 | 25.37 | 10.91 |
| Adjuvant A2-A7^{1), 2)} | 15 | 25 | 45 |
| Adjuvant B¹⁾ | | | |
| Cosolvent A¹⁾ | | | |
| Cosolvent B¹⁾ | 15 | 15 | 15 |
| Solvent¹⁾ | 2 | 2 | 2 |
| Buffer salt¹⁾ | 1 | 1 | 1 |
| Defoamer A1) | 0.08 | 0.08 | 0.08 |
| Water | 41.55 | 31.55 | 26.01 |
| Stability −10-54° C. (2 weeks) | 2 phases | 2 phases | 2 phases |

¹⁾Figures in % by weight
²⁾ In each case, formulations containing A2, A3, A4, A5, A6 or A7 were produced and examined

Formulations R1-R3 are not phase-stable with adjuvants A2-A7. This behavior was observed in the presence and absence of solvents.

### Example 4: Aqueous Glufosinate Formulations (Glufosinate-Ammonium 120 g/l a.e.)

The glufosinate ammonium preparations listed in table 3 were produced by mixing the various components with water. The preparations are then stored for 2 weeks at −10° C., 0° C., 25° C. (room temperature), and 54° C. to determine their storage stability and phase behavior.

TABLE 3
Compositions of aqueous glufosinate formulations (glufosinate-ammonium 120 g/l a.e.)

| | C1 | C2 | C3 | C4 | C5 | C6 | C7 | C8 | C9 | C10 | C11 | C12 | C13 |
|---|---|---|---|---|---|---|---|---|---|---|---|---|---|
| Pesticide A¹⁾ | 10.91 | 10.91 | 10.91 | 10.91 | 10.91 | 10.91 | 10.91 | 10.91 | 10.91 | 10.91 | 10.91 | 10.91 | 10.91 |
| Adjuvant A1¹⁾ | 3.75 | 7.5 | 15 | 22.5 | | | | | | | | | |
| Adjuvant A2¹⁾ | | | | | 3.75 | 7.5 | 15 | 22.5 | | | | | |
| Adjuvant A3¹⁾ | | | | | | | | | 3.75 | 7.5 | 15 | 22.5 | |
| Adjuvant A4¹⁾ | | | | | | | | | | | | | 3.75 |
| Adjuvant A5¹⁾ | | | | | | | | | | | | | |
| Adjuvant A6¹⁾ | | | | | | | | | | | | | |
| Adjuvant A7¹⁾ | | | | | | | | | | | | | |
| Adjuvant B¹⁾ | 11.25 | 7.5 | 30 | 22.5 | 11.25 | 7.5 | 30 | 22.5 | 11.25 | 7.5 | 30 | 22.5 | 11.25 |
| Cosolvent A¹⁾ | | | | | | | | | | | | | |
| Cosolvent B¹⁾ | 15 | 15 | 15 | 15 | 15 | 15 | 15 | 15 | 15 | 15 | 15 | 15 | 15 |
| Solvent¹⁾ | 2 | 2 | 2 | 2 | 2 | 2 | 2 | 2 | 2 | 2 | 2 | 2 | 2 |
| Buffer salt¹⁾ | 1 | 1 | 1 | 1 | 1 | 1 | 1 | 1 | 1 | 1 | 1 | 1 | 1 |
| Defoamer A1) | 0.08 | 0.08 | 0.08 | 0.08 | 0.08 | 0.08 | 0.08 | 0.08 | 0.08 | 0.08 | 0.08 | 0.08 | 0.08 |
| Water | 56.01 | 56.01 | 26.01 | 26.01 | 56.01 | 56.01 | 26.01 | 26.01 | 56.01 | 56.01 | 26.01 | 26.01 | 56.01 |
| Stability | stable | stable | stable | stable | stable | stable | stable | stable | stable | stable | stable | stable | stable |
| −10-54° C. | | | | | | | | | | | | | |
| (2 weeks) | | | | | | | | | | | | | |

| | C14 | C15 | C16 | C17 | C18 | C19 | C20 | C21 | C22 | C23 | C24 |
|---|---|---|---|---|---|---|---|---|---|---|---|
| Pesticide A¹⁾ | 10.91 | 10.91 | 10.91 | 10.91 | 10.91 | 10.91 | 10.91 | 10.91 | 10.91 | 10.91 | 10.91 |
| Adjuvant A1¹⁾ | | | | | | | | | | | |
| Adjuvant A2¹⁾ | | | | | | | | | | | |
| Adjuvant A3¹⁾ | | | | | | | | | | | |
| Adjuvant A4¹⁾ | 7.5 | 15 | | | | | | | | | |
| Adjuvant A5¹⁾ | | | 3.75 | 7.5 | 15 | | | | | | |
| Adjuvant A6¹⁾ | | | | | | 3.75 | 7.5 | 15 | | | |
| Adjuvant A7¹⁾ | | | | | | | | | 3.75 | 7.5 | 15 |
| Adjuvant B¹⁾ | 7.5 | 30 | 11.25 | 11.25 | 7.5 | 30 | 22.5 | 11.25 | 7.5 | 30 | 11.25 |
| Cosolvent A¹⁾ | | | | | | | | | | | |
| Cosolvent B¹⁾ | 15 | 15 | 15 | 15 | 15 | 15 | 15 | 15 | 15 | 15 | 15 |
| Solvent¹⁾ | 2 | 2 | 2 | 2 | 2 | 2 | 2 | 2 | 2 | 2 | 2 |
| Buffer salt¹⁾ | 1 | 1 | 1 | 1 | 1 | 1 | 1 | 1 | 1 | 1 | 1 |
| Defoamer A1) | 0.08 | 0.08 | 0.08 | 0.08 | 0.08 | 0.08 | 0.08 | 0.08 | 0.08 | 0.08 | 0.08 |
| Water | 56.01 | 26.01 | 56.01 | 56.01 | 26.01 | 56.01 | 56.01 | 26.01 | 56.01 | 56.01 | 26.01 |
| Stability | stable | stable | stable | stable | stable | stable | stable | stable | stable | stable | stable |
| −10-54° C. | | | | | | | | | | | |
| (2 weeks) | | | | | | | | | | | |

¹⁾Figures in % by weight

The compositions of the invention are homogeneous and phase-stable at −10° C., 0° C., 25° C. (room temperature), and 54° C. Examples of C₁-C₄ are noninventive comparative examples. The use of the solvent is not absolutely necessary since analogous stability data were obtained when the formulations were prepared with or without solvent. Moreover, no differences were found in the use of cosolvent A or of cosolvent B. It has been found that stable formulations with the alkyl ether sulfates A2-A7 were obtained solely in the presence of adjuvant B.

### Example 5: Aqueous Glufosinate Formulations (Glufosinate-Ammonium 280 g/l a.e.)

The glufosinate ammonium preparations listed in table 4 were produced by mixing the various components with water. The preparations are then stored for 2 weeks at −10° C., 0° C., 25° C. (room temperature), and 54° C. to determine their storage stability and phase behavior.

TABLE 4
Compositions of aqueous glufosinate formulations (glufosinate-ammonium 280 g/l a.e.)

| | D1 | D2 | D3 | D4 | D5 | D6 | D7 | D8 | D9 | D10 | D11 | D12 | D13 | D14 | D15 |
|---|---|---|---|---|---|---|---|---|---|---|---|---|---|---|---|
| Pesticide A¹⁾ | 25.37 | 25.37 | 25.37 | 25.37 | 25.37 | 25.37 | 25.37 | 25.37 | 25.37 | 25.37 | 25.37 | 25.37 | 25.37 | 25.37 | 25.37 |
| Adjuvant A1¹⁾ | 3.75 | 7.5 | 6.25 | 12.5 | | | | | | | | | | | |
| Adjuvant A2¹⁾ | | | | | 3.75 | 7.5 | 6.25 | 12.5 | | | | | | | |
| Adjuvant A3¹⁾ | | | | | | | | | 3.75 | 7.5 | 6.25 | 12.5 | | | |
| Adjuvant A4¹⁾ | | | | | | | | | | | | | 3.75 | 7.5 | 6.25 |
| Adjuvant A5¹⁾ | | | | | | | | | | | | | | | |
| Adjuvant A6¹⁾ | | | | | | | | | | | | | | | |
| Adjuvant A7¹⁾ | | | | | | | | | | | | | | | |
| Adjuvant B¹⁾ | 11.25 | 7.5 | 18.75 | 12.5 | 11.25 | 7.5 | 18.75 | 12.5 | 11.25 | 7.5 | 18.75 | 12.5 | 11.25 | 7.5 | 18.75 |
| Cosolvent A¹⁾ | 10 | 10 | 10 | 10 | 10 | 10 | 10 | 10 | 10 | 10 | 10 | 10 | 10 | 10 | 10 |
| Cosolvent B¹⁾ | 0 | 0 | 0 | 0 | 0 | 0 | 0 | 0 | 0 | 0 | 0 | 0 | 0 | 0 | 0 |
| Solvent¹⁾ | 2 | 2 | 2 | 2 | 2 | 2 | 2 | 2 | 2 | 2 | 2 | 2 | 2 | 2 | 2 |
| Buffer salt¹⁾ | 1 | 1 | 1 | 1 | 1 | 1 | 1 | 1 | 1 | 1 | 1 | 1 | 1 | 1 | 1 |
| Defoamer A1) | 0.08 | 0.08 | 0.08 | 0.08 | 0.08 | 0.08 | 0.08 | 0.08 | 0.08 | 0.08 | 0.08 | 0.08 | 0.08 | 0.08 | 0.08 |
| Water | 46.55 | 46.55 | 36.55 | 36.55 | 46.55 | 46.55 | 36.55 | 36.55 | 46.55 | 46.55 | 36.55 | 36.55 | 46.55 | 46.55 | 36.55 |
| Stability −10-54° C. | stable | stable | stable | stable | stable | stable | stable | stable | stable | stable | stable | stable | stable | stable | stable |
| (2 weeks) | | | | | | | | | | | | | | | |

| | D16 | D17 | D18 | D19 | D20 | D21 | D22 | D23 | D24 | D25 | D26 | D27 | D28 |
|---|---|---|---|---|---|---|---|---|---|---|---|---|---|
| Pesticide A¹⁾ | 25.37 | 25.37 | 25.37 | 25.37 | 25.37 | 25.37 | 25.37 | 25.37 | 25.37 | 25.37 | 25.37 | 25.37 | 25.37 |
| Adjuvant A1¹⁾ | | | | | | | | | | | | | |
| Adjuvant A2¹⁾ | | | | | | | | | | | | | |
| Adjuvant A3¹⁾ | | | | | | | | | | | | | |
| Adjuvant A4¹⁾ | 12.5 | | | | | | | | | | | | |
| Adjuvant A5¹⁾ | | 3.75 | 7.5 | 6.25 | 12.5 | | | | | 3.75 | 7.5 | 6.25 | 12.5 |
| Adjuvant A6¹⁾ | | | | | | 3.75 | 7.5 | 6.25 | 12.5 | | | | |
| Adjuvant A7¹⁾ | | | | | | | | | | 3.75 | 7.5 | 6.25 | 12.5 |
| Adjuvant B¹⁾ | 12.5 | 11.25 | 7.5 | 18.75 | 12.5 | 11.25 | 7.5 | 18.75 | 12.5 | 11.25 | 7.5 | 18.75 | 12.5 |
| Cosolvent A¹⁾ | 10 | 15 | 15 | 15 | 15 | 15 | 15 | 15 | 15 | 15 | 15 | 15 | 15 |
| Cosolvent B¹⁾ | 0 | 0 | 0 | 0 | 0 | 0 | 0 | 0 | 0 | 0 | 0 | 0 | 0 |
| Solvent¹⁾ | 2 | 2 | 2 | 2 | 2 | 2 | 2 | 2 | 2 | 2 | 2 | 2 | 2 |
| Buffer salt¹⁾ | 1 | 1 | 1 | 1 | 1 | 1 | 1 | 1 | 1 | 1 | 1 | 1 | 1 |
| Defoamer A1) | 0.08 | 0.08 | 0.08 | 0.08 | 0.08 | 0.08 | 0.08 | 0.08 | 0.08 | 0.08 | 0.08 | 0.08 | 0.08 |
| Water | 36.55 | 41.55 | 41.55 | 31.55 | 31.55 | 41.55 | 41.55 | 31.55 | 31.55 | 41.55 | 41.55 | 31.55 | 31.55 |
| Stability −10-54° C. | stable | stable | stable | stable | stable | stable | stable | stable | stable | stable | stable | stable | stable |
| (2 weeks) | | | | | | | | | | | | | |

¹⁾Figures in % by weight

The compositions of the invention are homogeneous and phase-stable at −10° C., 0° C., 25° C. (room temperature), and 54° C. Examples of C₁-C₄ are noninventive comparative examples. The use of the solvent is not absolutely necessary since analogous stability data were obtained when the formulations were prepared with or without solvent. It has been found that stable formulations with the alkyl ether sulfates A2-A7 were obtained solely in the presence of adjuvant B.

### Example 6: Foam Test

Selected formulations were each diluted while stirring to a 4.0% solution for formulations C₁-C₂₇ from table 3 and to a 2.0% solution for formulations D1-D28 from table 4 in 100 ml of CIPAC D (340 ppm) water, and inverted 30 times. The foam volume formed and the foam volume remaining after 10 seconds, 1 minute, 3 minutes and 12 minutes were ascertained (see foam assessment according to CIPAC MT 47.2).

TABLE 5
Remaining foam volume after 10 seconds, 1 minute, 3 minutes
and 12 minutes for formulations C1-C24 from table 3

| | | Foam volume remaining in % | | | |
|---|---|---|---|---|---|
| | Concentration | after | after | after | after |
| Formulation | [% by wt.] | 10 s | 1 min | 3 min | 12 min |
| C1 | 4.0 | 96 | 86 | 41 | 30 |
| C2 | 4.0 | 96 | 77 | 33 | 28 |
| C3 | 4.0 | 100 | 55 | 30 | 16 |
| C4 | 4.0 | 100 | 54 | 27 | 20 |
| C5 | 4.0 | 96 | 37 | 12 | 7 |
| C6 | 4.0 | 80 | 21 | 10 | 5 |
| C7 | 4.0 | 43 | 10 | 5 | 0 |
| C8 | 4.0 | 40 | 4 | 0 | 0 |
| C9 | 4.0 | 85 | 19 | 10 | 0 |
| C10 | 4.0 | 62 | 0 | 0 | 0 |
| C11 | 4.0 | 77 | 10 | 4 | 0 |
| C12 | 4.0 | 50 | 4 | 0 | 0 |
| C13 | 4.0 | 94 | 55 | 6 | 4 |
| C14 | 4.0 | 40 | 0 | 0 | 0 |
| C15 | 4.0 | 66 | 8 | 5 | 4 |
| C16 | 4.0 | 99 | 32 | 11 | 7 |
| C17 | 4.0 | 49 | 10 | 7 | 6 |
| C18 | 4.0 | 6 | 0 | 0 | 0 |
| C19 | 4.0 | 91 | 18 | 10 | 6 |
| C20 | 4.0 | 100 | 14 | 9 | 6 |
| C21 | 4.0 | 11 | 0 | 0 | 0 |
| C22 | 4.0 | 39 | 7 | 6 | 5 |
| C23 | 4.0 | 6 | 0 | 0 | 0 |
| C24 | 4.0 | 14 | 3 | 0 | 0 |

The inventive compositions C5-C27 show a distinct reduction in foam formation compared to the noninventive reference compositions C₁-C₄.

TABLE 6
Remaining foam volume after 10 seconds, 1 minute, 3 minutes
and 12 minutes for formulations D1-D28 from table 3

| | | Foam volume remaining in % | | | |
|---|---|---|---|---|---|
| | Concentration | after | after | after | after |
| Formulation | [% by wt.] | 10 s | 1 min | 3 min | 12 min |
| Basta | 2.0 | 95 | 88 | 81 | 64 |
| D1 | 2.0 | 90 | 89 | 54 | 33 |
| D2 | 2.0 | 89 | 74 | 44 | 40 |
| D3 | 2.0 | 90 | 67 | 46 | 27 |
| D4 | 2.0 | 89 | 51 | 41 | 28 |
| D5 | 2.0 | 42 | 0 | 0 | 0 |
| D6 | 2.0 | 16 | 0 | 0 | 0 |
| D7 | 2.0 | 82 | 9 | 7 | 5 |
| D8 | 2.0 | 45 | 0 | 0 | 0 |
| D9 | 2.0 | 6 | 0 | 0 | 0 |
| D10 | 2.0 | 0 | 0 | 0 | 0 |
| D11 | 2.0 | 51 | 6 | 4 | 0 |
| D12 | 2.0 | 57 | 6 | 3 | 0 |
| D13 | 2.0 | 69 | 5 | 4 | 0 |
| D14 | 2.0 | 51 | 0 | 0 | 0 |
| D15 | 2.0 | 55 | 6 | 5 | 0 |
| D16 | 2.0 | 68 | 0 | 0 | 0 |
| D17 | 2.0 | 65 | 11 | 5 | 0 |
| D18 | 2.0 | 64 | 12 | 11 | 4 |
| D19 | 2.0 | 99 | 40 | 17 | 14 |
| D20 | 2.0 | 48 | 9 | 7 | 6 |
| D21 | 2.0 | 98 | 90 | 35 | 16 |
| D22 | 2.0 | 100 | 92 | 26 | 14 |
| D23 | 2.0 | 100 | 40 | 19 | 12 |
| D24 | 2.0 | 99 | 16 | 10 | 7 |
| D25 | 2.0 | 4 | 3 | 3 | 0 |
| D26 | 2.0 | 7 | 5 | 4 | 0 |
| D27 | 2.0 | 15 | 9 | 6 | 4 |
| D28 | 2.0 | 23 | 4 | 3 | 0 |

The inventive compositions D5-D27 show a distinct reduction in foam formation compared to the noninventive reference compositions D1-D4.

### Example 7: Dynamic Surface Tension

Dynamic surface tension was determined via the bubble pressure method (BP2100 tensiometer, Krüss). Given a timespan of relevance for the spray application of agrochemicals in aqueous dilution (called the surface age in the bubble pressure method) of 200 milliseconds (ms), the value for dynamic surface tension in [mN/m] correlates with the adhesion on plants that are difficult to wet, such as barley (cereal). A value of 50 mN/m (at 20-21° C.) with respect to water (72.8 mN/m) results in an improvement in the adhesion from “zero adhesion” (0%) to about 50% (Baur P., Pontzen R.; 2007; Basic features of plant surface wettability and deposit formation and the impact of adjuvant; in R. E. Gaskin ed. Proceedings of the 8th International Symposium on Adjuvant for Agrochemicals; Publisher: International Society for Agrochemical Adjuvant (ISAA), Columbus, Ohio, USA). The formulations listed in tables 7 and 8 were diluted to 2.5% with water and dynamic surface tension was measured.

TABLE 7
Dynamic surface tension of formulations C1-C24 from table 3

| | Amount | | | | |
|---|---|---|---|---|---|
| | [% by | Dynamic surface tension at 200 ms [mN/m] | | | |
| Formulation | weight] | 20 ms | 50 ms | 100 ms | 200 ms |
| C1 | 2.5 | 71.9 | 69.4 | 67.6 | 65.7 |
| C2 | 2.5 | 71.8 | 67.9 | 64.8 | 61.8 |
| C3 | 2.5 | 65.1 | 56.9 | 50.7 | 44.5 |
| C4 | 2.5 | 67.1 | 59.5 | 53.7 | 48.0 |
| C5 | 2.5 | 70.7 | 68.8 | 67.4 | 66.0 |
| C6 | 2.5 | 69.5 | 67.6 | 66.1 | 64.7 |
| C7 | 2.5 | 63.7 | 60.4 | 57.8 | 55.2 |
| C8 | 2.5 | 62.5 | 59.4 | 57.0 | 54.7 |
| C9 | 2.5 | 70.4 | 68.6 | 67.3 | 65.9 |
| C10 | 2.5 | 69.5 | 67.5 | 66.0 | 64.6 |
| C11 | 2.5 | 64.0 | 61.1 | 59.0 | 56.8 |
| C12 | 2.5 | 62.9 | 60.4 | 58.5 | 56.6 |
| C13 | 2.5 | 70.7 | 68.3 | 66.5 | 64.7 |
| C14 | 2.5 | 69.6 | 66.5 | 64.2 | 61.8 |
| C15 | 2.5 | 62.2 | 57.7 | 54.2 | 50.8 |
| C16 | 2.5 | 69.3 | 66.4 | 64.2 | 62.0 |
| C17 | 2.5 | 68.8 | 66.1 | 64.0 | 62.0 |
| C18 | 2.5 | 61.7 | 58.3 | 55.6 | 53.0 |
| C19 | 2.5 | 71.2 | 68.2 | 65.9 | 63.6 |
| C20 | 2.5 | 70.0 | 65.5 | 62.0 | 58.6 |
| C21 | 2.5 | 61.0 | 55.0 | 50.4 | 45.8 |
| C22 | 2.5 | 70.7 | 67.6 | 65.2 | 62.9 |
| C23 | 2.5 | 69.0 | 65.2 | 62.3 | 59.5 |
| C24 | 2.5 | 60.5 | 55.9 | 52.4 | 49.0 |

The compositions of the invention, compared to the reference compositions D1-D4, in most cases, even for low dosage, show adequate lowering of dynamic surface tensions, which suggests good sticking properties on the leaf surface.

TABLE 8
Dynamic surface tension for formulations D1-D28 from table 4

| | Amount | | | | |
|---|---|---|---|---|---|
| | [% by | Dynamic surface tension at 200 ms [mN/m] | | | |
| Formulation | weight] | 20 ms | 50 ms | 100 ms | 200 ms |
| D1 | 2.5 | 72.0 | 69.8 | 68.0 | 66.3 |
| D2 | 2.5 | 72.4 | 68.6 | 65.8 | 62.9 |
| D3 | 2.5 | 71.8 | 67.3 | 64.0 | 60.7 |
| D4 | 2.5 | 71.5 | 65.4 | 60.8 | 56.2 |
| D5 | 2.5 | 70.4 | 68.9 | 67.7 | 66.5 |
| D6 | 2.5 | 69.7 | 67.8 | 66.4 | 65.0 |
| D7 | 2.5 | 69.1 | 66.7 | 64.8 | 63.0 |
| D8 | 2.5 | 67.5 | 65.0 | 63.0 | 61.1 |
| D9 | 2.5 | 70.5 | 68.9 | 67.6 | 66.3 |
| D10 | 2.5 | 69.6 | 67.8 | 66.5 | 65.1 |
| D11 | 2.5 | 68.8 | 66.6 | 64.8 | 63.1 |
| D12 | 2.5 | 67.2 | 65.0 | 63.4 | 61.8 |
| D13 | 2.5 | 71.1 | 68.8 | 67.2 | 65.5 |
| D14 | 2.5 | 70.1 | 67.0 | 64.8 | 62.5 |
| D15 | 2.5 | 69.2 | 65.7 | 63.1 | 60.5 |
| D16 | 2.5 | 66.7 | 62.7 | 59.6 | 56.6 |
| D17 | 2.5 | 70.7 | 68.5 | 66.9 | 65.2 |
| D18 | 2.5 | 69.2 | 66.6 | 64.6 | 62.6 |
| D19 | 2.5 | 68.7 | 65.6 | 63.3 | 61.0 |
| D20 | 2.5 | 65.9 | 62.8 | 60.5 | 58.2 |
| D21 | 2.5 | 71.5 | 68.5 | 66.3 | 64.1 |
| D22 | 2.5 | 70.2 | 65.7 | 62.3 | 58.8 |
| D23 | 2.5 | 69.3 | 64.7 | 61.2 | 57.7 |
| D24 | 2.5 | 66.2 | 60.4 | 56.0 | 51.7 |
| D25 | 2.5 | 71.1 | 68.1 | 65.9 | 63.7 |
| D26 | 2.5 | 69.3 | 65.6 | 62.7 | 59.9 |
| D27 | 2.5 | 68.5 | 64.5 | 61.4 | 58.4 |
| D28 | 2.5 | 64.9 | 60.7 | 57.4 | 54.2 |

The compositions of the invention, compared to the reference compositions D1-D4, in most cases, even for low dosage, show adequate lowering of dynamic surface tensions, which suggests good sticking properties on the leaf surface.

### Example 8: Use of Glufosinate Compositions for Weed Control

Selected formulations according to tables 3 and 4 were diluted with water, so as to result in a water application rate of 120-400 I/ha at a customary application rate for glufosinate (300-1000 g/ha) for application to uncultivated land. These spray liquors were applied to a spectrum of mono- and dicotyledonous weed plants that had emerged under natural conditions. An evaluation of the effect after 4 weeks showed that the green parts of the harmful plants had died off, demonstrating that good control of the harmful plants had been achieved. For example, in terms of biological effect in the control of monocotyledonous and dicotyledonous weed plants, selected formulations from tables 3 and 4 showed improved results over the commercially available Basta formulation for the same application rate of glufosinate.

1. A composition comprising
a) a water-soluble herbicide,
b) a N-alkylglucamide of the formula (I) 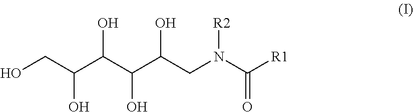
in which
R1 is a linear or branched alkyl group having 5 to 9 carbon atoms,
R2 is an alkyl group having 1 to 3 carbon atoms,
c) an alkyl ether sulfate having 1 to 10 carbon atoms in the alkyl chain and having 1 to 20 alkyleneoxy units in the ether moiety, and
d) water.

2. The composition as claimed in claim 1, further comprising at least one of the following constituents:
e) cosolvent selected from the group consisting of dihydric and trihydric alcohols and/or
f) further active agrochemical ingredient and/or
g) water-soluble macro- and/or micronutrient, and/or
h) further surfactant other than components b) and d), and/or
i) further customary formulation auxiliaries.

3. The composition as claimed in claim 1, wherein the water-soluble herbicide is a water-soluble acid or a salt of auxins, of glufosinate, or of glyphosate.

4. The composition as claimed in claim 3, wherein the water-soluble herbicide is a water-soluble salt of glufosinate.

5. The composition as claimed in claim 4, wherein the active agrochemical ingredient of component a) is glufosinate-ammonium.

6. The composition as claimed in claim 2, wherein the composition comprises the active agrochemical ingredient glufosinate as component a) and at least one further pesticide as component f).

7. The composition as claimed in claim 6, wherein the further pesticide is a herbicide.

8. The composition as claimed in claim 2, wherein the further active agrochemical ingredient of component f) is an insecticide or a growth regulator.

9. The composition as claimed in claim 1, wherein the composition comprises the active agrochemical ingredients of component a) in an amount of more than 10% by weight.

10. The composition as claimed in claim 1, comprising 18% to 40% by weight, of the active agrochemical ingredient of component a) and no further active agrochemical ingredients.

11. The composition as claimed in claim 2, which contains 1% to 80% by weight of the active agrochemical ingredient of component a) and 1% to 80% by weight of one or more further active agrochemical ingredients of component f).

12. The composition as claimed in claim 1, which comprises, as component b), one or more alkylglucamides of the formula (I) in which the R1 radical is a linear or branched alkyl group having 7 to 9 carbon atoms and the R2 radical is a methyl group.

13. The composition as claimed in claim 2, which further comprises, as component e), propylene glycol, glycerol or combinations thereof.

14. The composition as claimed in claim 1, which comprises, as component c), (C₈-C₁₀)-alkyl (poly)ethylene glycol ether sulfates with 3 to 5 EO.

15. The composition as claimed in claim 14, wherein it comprises, as component c), compounds of the formula (II)
R—O—(CH₂CH₂O)ₙ-SC₃⁻M⁺ (II)
in which
R denotes a C₈-C₁₀-alkyl group,
n is an integer from 3 to 5 that denotes the number of ethyleneoxy groups in the (poly)ethyleneoxy bridge, and
M denotes a monovalent cation.

16. The composition as claimed in claim 2, which takes the form of a concentrate formulation containing
a) 1% to 80% by weight, of the active agrochemical ingredient of component a),
b) 0.1% to 97% by weight, of one or more alkylglucamides of the formula (I),
c) 0.1% to 97% by weight, of one or more alkyl ether sulfates having 8 to 10 carbon atoms in the alkyl chain and having 1 to 20 alkyleneoxy units in the ether moiety,
d) 0.01% to 95% by weight, of water,
e) 0% to 30% by weight, of one or more di- or trihydric alcohols as cosolvents,
f) 0% to 80% by weight, of one or more active agrochemical ingredients,
g) 0% to 25% by weight, of water-soluble macro- and/or micronutrients, especially nitrogen-containing inorganic ammonium salts and/or urea (derivatives),
h) 0% to 25% by weight, of further surfactants other than the surfactants of components b) and d), and
i) 0% to 50% by weight, of further customary formulation auxiliaries.

17. The composition as claimed in claim 2, which takes the form of a spray liquor and contains
0.001% to 10% by weight, of water-soluble herbicide of component a),
0.001% to 10% by weight, of the one or more further pesticides of component f).

18. A method for control and/or abatement of weeds, fungal diseases or insect infestation in plants comprising the step of contacting the weeds, fungal diseases or insects with at least one composition comprising
a) a water-soluble herbicide,
b) a N-alkylglucamide of the formula (I) 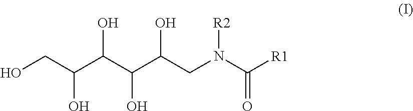
in which
R1 is a linear or branched alkyl group having 5 to 9 carbon atoms,
R2 is an alkyl group having 1 to 3 carbon atoms,
c) an alkyl ether sulfate having 1 to 10 carbon atoms in the alkyl chain and having 1 to 20 alkyleneoxy units in the ether moiety, and
d) water.

19. A method for improving the biological action for control of weeds, fungal diseases or insect infestation in plants comprising the step of contacting the weeds, fungal diseases or insects with at least one composition comprising
a) a water-soluble herbicide,
b) a N-alkylglucamide of the formula (I) 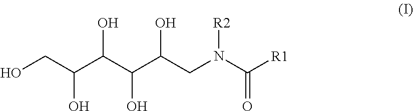
in which
R1 is a linear or branched alkyl group having 5 to 9 carbon atoms,
R2 is an alkyl group having 1 to 3 carbon atoms,
c) an alkyl ether sulfate having 1 to 10 carbon atoms in the alkyl chain and having 1 to 20 alkyleneoxy units in the ether moiety, and
d) water.

20. A method for reducing the tendency to foaming of a formulation during production, comprising the step of adding at least one composition comprising
a) a water-soluble herbicide,
b) a N-alkylglucamide of the formula (I) 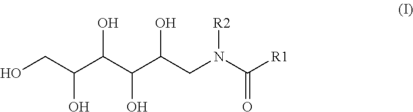
in which
R1 is a linear or branched alkyl group having 5 to 9 carbon atoms,
R2 is an alkyl group having 1 to 3 carbon atoms,
c) an alkyl ether sulfate having 1 to 10 carbon atoms in the alkyl chain and having 1 to 20 alkyleneoxy units in the ether moiety, and
d) water, to the formulation.
